(19) United States
(12) Patent Application Publication
(10) Pub. No.: US 2009/0030785 A1
(43) Pub. Date: Jan. 29, 2009

(54) MONETIZING RICH MEDIA ADVERTISING INTERACTION

(75) Inventors: Prabhakar Goyal, Mountain View, CA (US); Jatin Patel, Cupertino, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/828,789

(22) Filed: Jul. 26, 2007

(51) Int. Cl. G06Q 30/00

(52) U.S. Cl. 705/14

(57) ABSTRACT

A method for calculating brand index (BI) for interactive rich media advertising produces a brand effectiveness model, and includes categorizing advertising exposure of a rich media ad into a type of bucket, and for each type of bucket: assigning a weight (Wⱼ) to each of a plurality of data types collected in the bucket; assigning a score (Dⱼ) to each of the data types collected in the bucket; tracking a frequency (Nⱼ) of occurrence of each data type; and calculating a bucket brand index (BBIᵢ)=ΣWⱼ*Nⱼ*Dⱼ. A non-linear approach to calculating BBI may also be used. A bucket weight (Wᵢ) is assigned to each type of bucket; the BI is calculated as a weighted sum of the plurality of bucket brand indexes (BBI)=ΣWᵢ*BBIᵢ, and the BI is communicated to an advertiser or publisher for an ad campaign that includes the BBIᵢ to indicate monetization value of the rich media ad.

### BACKGROUND

1. Technical Field

The disclosed embodiments relate to a system and its methods for monetizing rich media advertising interaction, and more particularly, for translating user interaction with rich media advertising into brand effectiveness models.

2. Related Art

Use of rich media advertising online, e.g. over the internet, has been rising rapidly. The ability of rich media ads to engage and entertain, enhanced with an ability to interact with the user, makes them very effective for brand advertisers. Rich media ads are significantly more effective and provide much higher value for both advertiser and publishers than non-rich ads. For example, rich media ads when compared with non-rich media banner ads provide: (1) much better brand lift for brand advertisers; (2) about five times the click-through rates for performance marketers; and (3) significantly higher cost per thousand (CPM) clicks for publishers (up to two times higher).

While online advertising has ushered into the twenty-first century via rich media advertising technology, the business and monetization models around this form of advertising lag behind. Though user interaction with the ad is considered very valuable, and is a direct indicator of the ad effectiveness, any consistent measurement and models to translate user interaction into brand effectiveness have been largely missing. The rich media ads purchases are still based on CPM, and in smaller numbers on cost per click (CPC) and cost per action (CPA) models of the old static banner world. These monetization models, though implicitly account for value of user interaction, provide sub-optimal value for publishers. Since there are no models for translating rich media exposure and user interaction into brand effectiveness, ad campaigns also cannot be efficiently optimized. In addition, this lack of measurement makes it harder for marketers to allocate advertising budget against the stated goal in an optimal way.

### SUMMARY

By way of introduction, the embodiments described below include a system and methods for monetizing rich media advertising interaction, and more particularly, for translating user interaction with rich media advertising into brand effectiveness models.

In a first aspect, a method is disclosed for calculating brand index (BI) for interactive rich media advertising, including categorizing advertising exposure of a rich media ad and associated user interaction with the rich media ad into a set of buckets stored in memory as determined by a processor, assigning a bucket weight in memory to each categorized bucket, and calculating a bucket brand index (BBI) for each bucket, wherein a campaign for the rich media ad includes a plurality of BBIs. The method further includes calculating a weighted sum of the plurality of BBIs to generate an overall brand index (BI) for the campaign by summing the weight of each bucket times the BBI of each respective bucket, and communicating the BI of the campaign to an advertiser or publisher as an indication of the monetization value of the rich media ad.

In a second aspect, a method is disclosed for calculating brand index (BI) for interactive rich media advertising that produces a brand effectiveness model. The method includes categorizing advertising exposure of a rich media ad into a type of bucket in memory, and for each type of bucket by a processor: assigning a weight to each of a plurality of data types collected in the bucket stored in memory, assigning a score in memory to each of the data types collected in the bucket, tracking a frequency of occurrence of each data type, and calculating a bucket brand index (BBI) for the bucket as a product of the assigned weight, the assigned score, and the tracked frequency. The method further includes assigning a bucket weight to each type of bucket stored in memory, calculating a weighted sum of a plurality of BBIs of the buckets to generate an overall brand index (BI) for an ad campaign by summing the weight of each bucket times the BBI of each respective bucket, and communicating the BI of the campaign to an advertiser or publisher as an indication of the monetization value of the rich media ad.

In a third aspect, a method is disclosed for calculating brand index (BI) for interactive rich media advertising, including categorizing advertising exposure of a rich media ad into a type of bucket in memory, and for each type of bucket a processor: collecting a plurality of data types (d₁, d₂, . . . , dₘ) in the bucket stored in memory, and expressing a bucket brand index (BBI) as a function of the plurality of data types, f(d₁, d₂, . . . , dₘ), wherein the function is finite, non-negative, and real for all non-negative and finite (d). The method further includes assigning a bucket weight to each type of bucket stored in memory, calculating a weighted sum of a plurality of BBIs of the buckets to generate an overall brand index (BI) for an ad campaign by summing the weight of each bucket times the BBI of each respective bucket, and communicating the BI of the campaign to an advertiser or publisher as an indication of the monetization value of the rich media ad.

In a fourth aspect, a method is disclosed for calculating brand index (BI) for interactive rich media advertising, including categorizing advertising exposure of some of a plurality of rich media ads into a first type of bucket stored in memory, and for each first type of bucket a processor: assigning a weight to each of a plurality of data types collected in the bucket, assigning a score to each of the data types collected in the bucket, tracking a frequency of occurrence of each data type, and calculating the bucket brand index (BBI) for the bucket as a product of the assigned weight, the assigned score, and the tracked frequency. The method further includes categorizing advertising exposure of the remainder of the plurality of rich media ads into a second type of bucket stored in memory, and for each second type of bucket the processor: collecting a plurality of data types (d₁, d₂, . . . , dₘ) in the bucket stored in memory, and expressing a bucket brand index (BBI) as a function of the plurality of data types, f(d₁, d₂, . . . , dₘ), wherein the function is finite, non-negative, and real for all non-negative and finite (d). The method further includes assigning a bucket weight to each first and second types of buckets stored in memory, calculating a weighted sum of a plurality of BBIs of the first and second buckets to generate an overall brand index (BI) for an ad campaign by summing the weight of each bucket times the BBI of each respective bucket, and communicating the BI of the campaign to an advertiser or publisher as an indication of the monetization value of the rich media ad.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary rich media advertising interaction and optimization system including a campaign management server and an advertising web server.

FIG. 2 is a diagram depicting the contents of the buckets database of FIG. 1.

FIGS. 3A and 3B are diagrammatic examples depicting further contents of the buckets database in which FIG. 3A shows a linear relation between bucket brand index (BBI) and a bucket's tracked parameters and FIG. 3B shows a non-linear relationship of the same based on the data types in the bucket.

FIG. 3C is a diagrammatic example of a combination of the methods used in FIGS. 3A and 3B to determine the BBIs of each bucket.

FIG. 4 is a flow chart of an exemplary method for monetizing rich media advertising by calculating brand index for an interactive rich media ad campaign.

FIG. 5 is a flow chart of a further exemplary method for monetizing rich media advertising by calculating brand index for an interactive rich media ad campaign.

FIG. 6 is a flow chart of another method for monetizing rich media advertising by calculating brand index for an interactive rich media ad campaign.

### DETAILED DESCRIPTION

In the following description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

The ways in which a user can interact with the ads are numerous and only limited by the imagination of the ad creator. But these user interactions can be broadly classified based on the impact they make on the user with respect to brand lift. In this application are described these broad categories and a model is proposed to translate user interaction into brand effectiveness of the ad. Any proposed brand effectiveness model needs to have certain properties for it to be useful and widely accepted. These properties are described below. Note that some of these properties are contradictory in their goals, and hence, they require balancing.

Consistency: Brand effectiveness measured using this model should be consistent with widely accepted methods currently used in industry. For example, the measurement based on the model should correlate positively, and preferably proportionally, with user sampling and survey methods used for measuring brand lift.

Ease of use: The model should be easy to understand, e.g., it would be useful for the model to produce a single numeric value as the measurement of the brand effectiveness.

Computation Complexity: The model should not be prohibitively expansive to compute when applied to large numbers of impressions and associated interaction data.

Allow Comparison: The model should allow comparison of brand effectiveness from any two ads as long as necessary data from each ad campaign is available. This is to allow optimization between ad campaigns.

Absolute Index: To allow monetization to be based on brand effectiveness, the model should provide absolute index of effectiveness. Once this index has been established, rich media ad campaigns can be sold based on the index as oppose to a cost per thousands (CPM) model.

Account for varieties of user interactions: The model should account for wide varieties of user interaction associated with rich media ads. In fact, it should be easy to incorporate new interaction types, preferably without having to fundamentally change the model. This may mean that the interactions need to be generalized on a set of common types. At the same time, generalization of user interaction should not dilute the value and differences between interaction types, which would make the model ineffective.

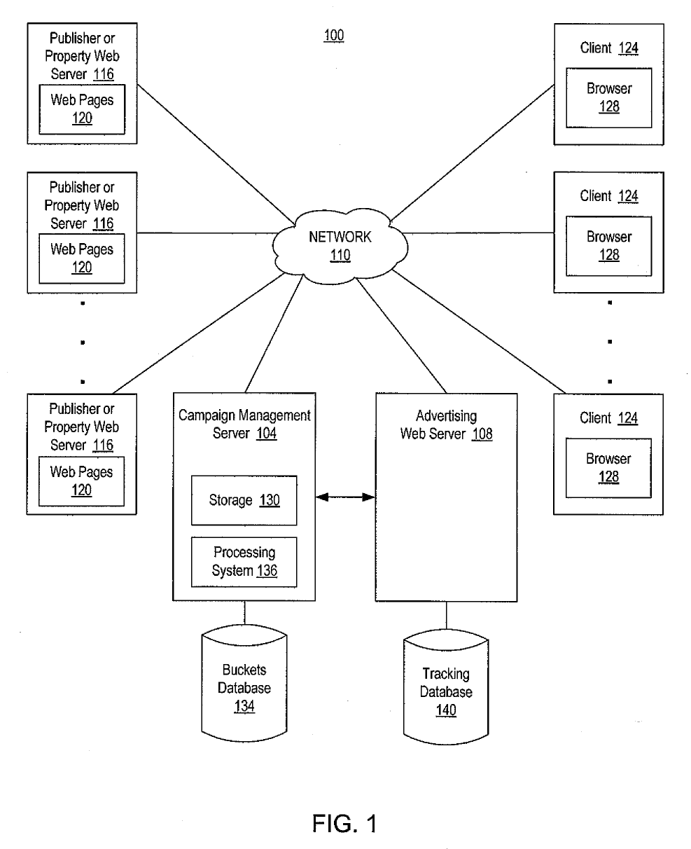

FIG. 1 is a diagram of an exemplary rich media advertising interaction and optimization system 100 including a campaign management server 104 and an advertising web server 108 (hereinafter “ad server 108”). The campaign manager server 104 and the ad server 108 communicate over a network 110 with web servers 116 of publishers or properties that publish content web pages 120. They also communicate over the network with client computers 124 (herein after “clients 124”) through web browsers 128 of each client 124. The clients 124 communicate with the publisher web servers 116 through the network 110 to download web pages 120 having content published by the publishers. Simultaneously, the publisher web servers 120 communicate with the campaign management server 104 and the ad server 108 to load into the web pages 120 appropriate advertising content based on at least the advertising campaigns of the publishers or properties. Note that the network 110 may include a local area network (LAN), a wide area network (WAN), the internet or World Wide Web (WWW), or other type of network.

The campaign management server 104 further includes or communicates with memory storage 130 and a buckets database 134. One of skill in the art will appreciate that the storage 130 and buckets database 134 may be combined physically or distributed across multiple storage devices, including across the network 110. The campaign manager server 104 also includes a processing system 136 having a processor (not shown) as is know in the art for executing software or other executable code to implement the methods disclosed herein. Finally, the ad server 108 includes or communicates with a tracking database 140 that together aid the campaign management server 104 to track various parameters related to an ad campaign, such as the frequency of access of the various rich media ads employed, which parameters also relate to the type of user interaction. One of skill in the art will also appreciate that the buckets database 134 and the tracking database 140 may be directly linked or be the same physical database in some embodiments. Note also that the campaign management server 104 and the ad server 108 may also directly communicate with each other, communicate over the network 110, or may be integrated into a single server.

The tracking database 140 may also store information regarding the browsing and interaction of the client 124 users with the rich media ads, including, but not limited to: clicking, downloading, printing (such as a coupon or gift card), exposing certain layers of an ad, expanding an ad with a mouse motion over the ad, playing and/or pausing audio or video feeds. This type of information, later referred to as a “data type,” may be obtained through tracking the user's direct interaction with a variety of different rich media ads, and a score is assigned to such interaction according to importance or relevance to an ad campaign of a publisher or an advertiser. Thus, for instance, a download or purchase may receive a high score, such as a 9 or 10, and expanding an ad with mouse motion or exposing ad layers may receive a lower score, such as from a 1 to a 3. Use of the score to develop a monetization model for rich media ads will be covered below.

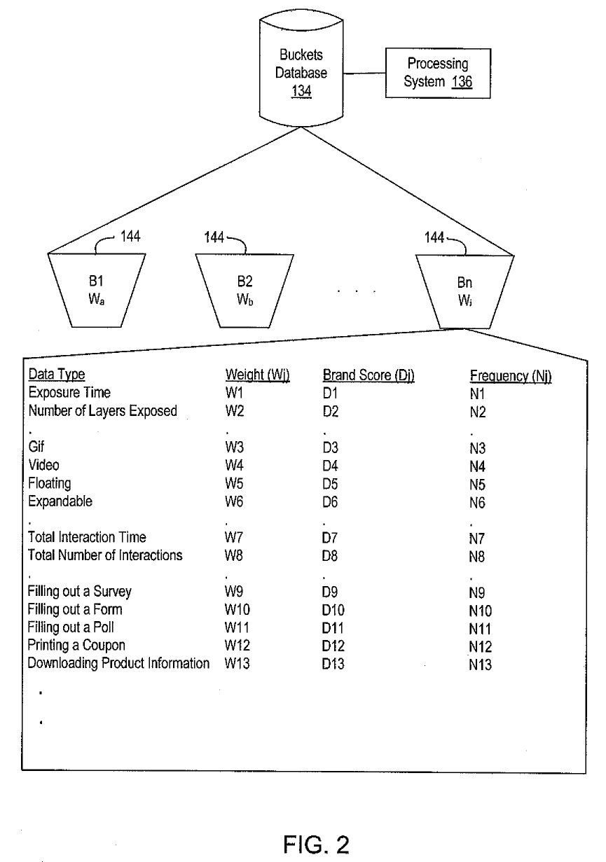

FIG. 2 is a diagram depicting the contents of the buckets database 134 of FIG. 1. This disclosure proposes a model for calculating brand index (BI) as a function of ad exposure and various client 124 user interactions. The model works by categorizing ad exposure and interactions into a set of buckets 144, which are stored in the buckets database 134. Each bucket is assigned a weight (W). Interaction and exposure data is collected into these buckets and a bucket brand index (BBI) is calculated. The overall brand index (BI) is calculated as the weighted sum of BBIs, for instance, by calculating ΣWᵢ*BBIᵢ. In this equation, BI is the overall brand index for a campaign, BBIᵢ is the bucket brand index for the ith bucket 144, and Wᵢ is the weight associated with the ith bucket 144.

Brand index-per-impression (BII) can be calculated by dividing the BI with the number of impressions. The method of calculating the BBI is dependent upon the characteristics of the data collected in the bucket 144. As is learned more from empirical data, new schemes for calculating BBI for different bucket types will be developed. Outlined now are two schemes for calculating BBI that may be executed separately, and a third scheme wherein the two schemes are mixed in their execution where choice of one of these schemes depends on the types of data in a rich media ad campaign, among other factors.

As will be further explained in the specific schemes for models explained herein, each bucket 144 may also include various data types of rich media, to include, but not limited to: exposure time, number of advertising layers exposed, .gif pictures, motion video, floating ads, expandable ads, total interaction time with an ad, total number of interactions, filling out a survey or other form or a poll, printing a coupon, or downloading product information. A weight (Wⱼ) and a brand score (Dⱼ) to each data type, and a frequency of access (Nⱼ) is tracked for each data type and associated therewith in each bucket 144 according to category.

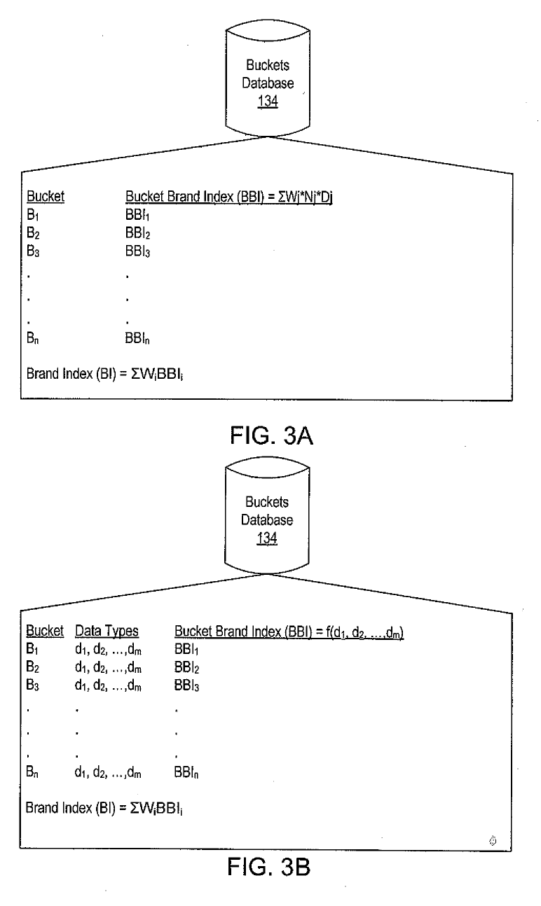

FIGS. 3A and 3B are diagrammatic examples depicting further contents of the buckets database 134 in which FIG. 3A shows a linear relation between bucket brand index (BBI) and tracked parameters of a bucket 144 and FIG. 3B shows a non-linear relationship of the same based on the data types in the bucket 144.

In FIG. 3A, the modeling scheme is similar to the method used for calculating overall brand index. Each data type collected in the bucket 144 is assigned a fixed score (Dⱼ) and a weight (Wⱼ), as previously discussed. The BBI is calculated as a weighted sum of the data scores (Dⱼ) in the bucket 144. If data from certain data types occur multiple times (e.g., a certain ad layer was opened multiple times by the client 124 user), the score (Dⱼ) is simply multiplied by the number of occurrences, or the BBI=ΣWⱼ*Nⱼ*Dⱼ. In this equation, BBI is the bucket brand index, Wⱼ is the weight associated with the jth data type in the bucket 144, Dⱼ is the brand score for jth data type, and Nⱼ is the number of occurrences for the jth data type.

In FIG. 3B, the modeling scheme is based on a production function, which is commonly used in economics to summarize the process of conversion of factors into a particular commodity. The BBI function in this case is expressed in the following general form: BBI=f(d₁, d₂, . . . , dₘ). The BBI depends on a series of data types collected in the bucket 144, and generally will yield diminishing returns over time. These data types are represented as variables d₁, d₂, . . . , dₘ.

Characteristics of the function include that f(d) is finite, non-negative, real-valued and single-valued for all non-negative and finite d. A function f(0, 0, . . . , 0) equals 0, or in other words, no ad exposure and no user interaction implies zero brand index. If d>=d′, then f(d)>=f(d′), or monotonicity, i.e., an increase in exposure or interaction does not decrease BBI. Alternatively, for BBI=f (d₁, d₂, . . . , dₘ), dBBI/ddᵢ=fᵢ>0 for all data type inputs i=1, 2, . . . , m. The BBI function is also assumed to have “quasi-concavity” of the production function, i.e., d²BBI/ddᵢ²=fᵢᵢ<0 for all i=1, . . . , m, i.e., a diminishing marginal index. The implication is that each additional unit of ad exposure and interactivity will increase the BBI but by smaller and smaller increments.

User (or client 124) interaction and exposure bucketization may follow the following broad classification of rich media exposure and interaction data. Note that the data types below correspond to those listed in FIG. 2 and are only exemplary of the types of data that a bucket 144 may include in order to build a model of a rich media ad campaign.

Exposure Bucket:

BBI Model: Diminishing Returns (non-linear)

Data Types: Exposure Time, Number of Layers Exposed

Ad Format and Media Type Bucket:

BBI Model: Linear

Data Types: Gif, Video, Floating, Expandable

Interaction Bucket:

BBI Model: Diminishing Returns (non-linear)

Data Types: Total Interaction Time, Total Number of Interactions

Conversion Bucket:

BBI Model: Linear

Data Types: Filling a Survey, Form, or Poll, Printing Coupon, Downloading Product Information

FIG. 3C is a diagrammatic example of a combination of the methods used in FIGS. 3A and 3B to determine the BBIs of each bucket. Under the “data types” column, note that “linear” corresponds to those types of data listed above that correspond to the method of FIG. 3A for determining BBI. Additionally, the “d₁, d₂, . . . , dₘ” indicates that a (non-linear) production function such as in FIG. 3B is being used to calculate BBI. FIG. 3C thus indicates that BBI may be calculated in various ways within the same campaign based on mixed data types in the buckets database 134. The brand index (BI), however, is still calculated the same, e.g. the weighted sum of each BBI for each of the individual buckets 144, or ΣWᵢ*BBIᵢ.

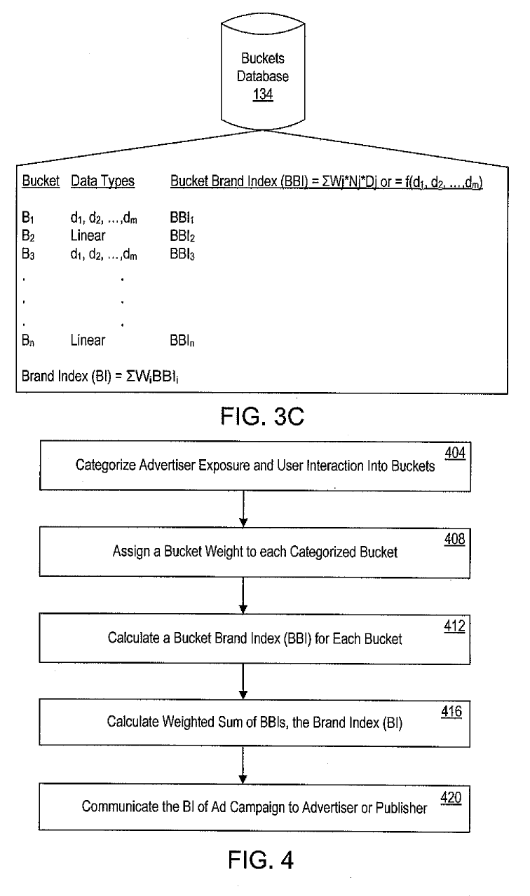

FIG. 4 is a flow chart of an exemplary method for monetizing rich media advertising by calculating brand index (BI) for an interactive rich media ad campaign. As shown, at step 404, the method categorizes advertising exposure of a rich media ad and associated user 124 interaction with the rich media ad into a set of buckets 144 stored in database 134 as determined by a processor. A bucket weight is assigned in database 134 to each categorized bucket 144, at step 408. A bucket brand index (BBI) is calculated for each bucket 144, at step 412, wherein the campaign for the rich media ad comprises a plurality of BBIs. A weighted sum of the plurality of BBIs is calculated, at step 416, to generate an overall brand index (BI) for the campaign by summing the weight of each bucket 144 times the BBI of each respective bucket 144. The BI of the campaign is communicated, at step 420, to an advertiser or publisher as an indication of the monetization value of the rich media ad.

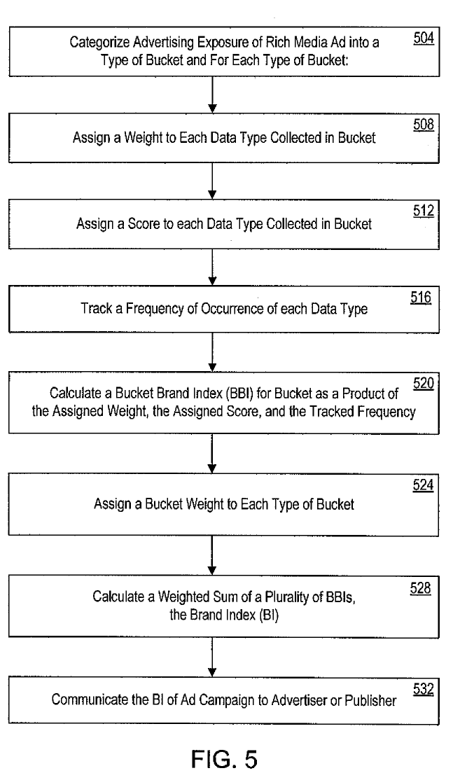

FIG. 5 is a flow chart of a further exemplary method for monetizing rich media advertising by calculating brand index (BI) for an interactive rich media ad campaign. At step 504, the method categorizes advertising exposure of a rich media ad into a type of bucket 144 stored in the database 134, and for each type of bucket 144, a processor executes the following steps. A weight is assigned to each data type collected in the bucket 144, at step 508. A score is assigned in the database 134 to each data type collected in the bucket 144, at step 512. A frequency of occurrence of each data type is tracked, at step 516. A bucket brand index (BBI) is calculated by multiplying the assigned weight times the assigned score times the tracked frequency in each bucket 144, at step 520. Once these steps are performed for each bucket 144, a bucket weight is then assigned to each type of bucket 144 stored in the database 134, at step 524, and a brand index (BI) for the ad campaign is calculated by summing the bucket weight times the respective BBI of each bucket 144, at step 528, e.g. a weighted sum of a plurality of BBIs. The BI of the campaign is communicated, at step 532, to an advertiser or publisher as an indication of the monetization value of the rich media ad. See also FIGS. 2 and 3A.

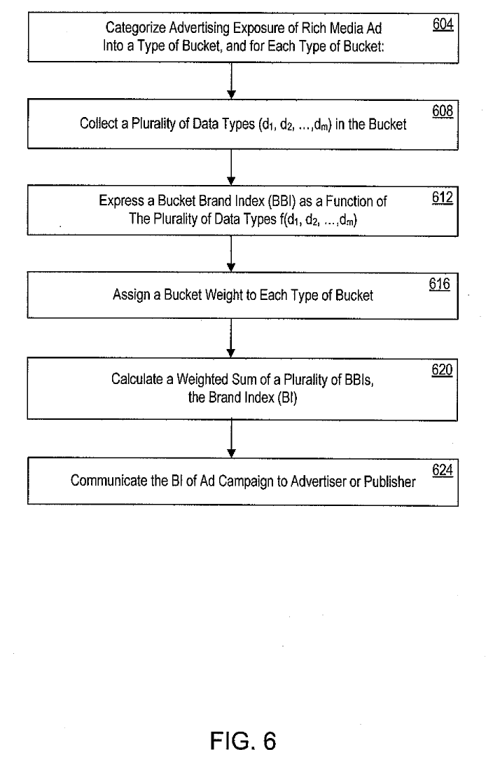

FIG. 6 is a flow chart of another method for monetizing rich media advertising by calculating brand index (BI) for an interactive rich media ad campaign. At step 604, the method categorizes advertising exposure of a rich media ad into a type of bucket 144 stored in the database 134, and for each type of bucket 144, a processor executes the following steps. A plurality of data types (d₁, d₂, . . . , dₘ) are collected in the bucket 144, at step 608. The bucket brand index (BBI) is expressed as a function of the plurality of data types f(d₁, d₂, . . . , dₘ), at step 612, where the function is finite, non-negative, and real for all non-negative and finite (d). Once these steps are executed for each type of bucket 144, a bucket weight is assigned to each type of bucket 144 stored in the database 134, at step 616, and a brand index (BI) is calculated by summing the bucket weight times the respective BBI of each bucket 144, at step 620. The BI of the campaign is communicated, at step 624, to an advertiser or publisher as an indication of the monetization value of the rich media ad. See also FIGS. 2 and 3B.

Note also that the steps, as explained with reference to FIG. 3C, of the methods disclosed in FIGS. 5 and 6 may be combined because BBI may be calculated with a linear or a non-linear approach in any of the buckets 144 of the buckets database 134, after which the overall BI may be calculated as in either steps 524 and 528 or steps 616 and 620.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A method for calculating brand index (BI) for interactive rich media advertising, comprising:
categorizing advertising exposure of a rich media ad and associated user interaction with the rich media ad into a set of buckets stored in memory as determined by a processor;
assigning a bucket weight in memory to each categorized bucket;
calculating a bucket brand index (BBI) for each bucket, wherein a campaign for the rich media ad comprises a plurality of BBIs;
calculating a weighted sum of the plurality of BBIs to generate an overall brand index (BI) for the campaign by summing the weight of each bucket times the BBI of each respective bucket; and
communicating the BI of the campaign to an advertiser or publisher as an indication of the monetization value of the rich media ad.

2. The method of claim 1, wherein for a linear method of determining BI, calculating the BBI for each bucket comprises:
assigning a weight to each of a plurality of data types collected in the bucket;
assigning a score to each of the data types collected in the bucket;
tracking a frequency of occurrence of each data type; and
calculating a bucket brand index (BBI) for the bucket as a product of the assigned weight, the assigned score, and the tracked frequency.

3. The method of claim 1, wherein for a non-linear method of determining BI, calculating the BBI for each bucket comprises:
collecting a plurality of data types (d₁, d₂, . . . , dₘ) in the bucket; and
expressing a bucket brand index (BBI) as a function of the plurality of data types, f(d₁, d₂, . . . , dₘ), wherein the function is finite, non-negative, and real for all non-negative and finite (d).

4. The method of claim 1, further comprising:
calculating a brand index per impression (BJJ) as a ratio of BI and a number of impressions.

5. The method of claim 1, wherein communicating the BI to an advertiser comprises communicating the BI to an advertising server.

6. A method for calculating brand index (BI) for interactive rich media advertising, comprising:
categorizing advertising exposure of a rich media ad into a type of bucket stored in memory, and for each type of bucket by a processor:
assigning a weight to each of a plurality of data types collected in the bucket;
assigning a score in memory to each of the data types collected in the bucket;
tracking a frequency of occurrence of each data type; and
calculating a bucket brand index (BBI) for the bucket as a product of the assigned weight, the assigned score, and the tracked frequency;
assigning a bucket weight to each type of bucket stored in memory;
calculating a weighted sum of a plurality of BBIs of the buckets to generate an overall brand index (BI) for an ad campaign by summing the weight of each bucket times the BBI of each respective bucket; and
communicating the BI of the campaign to an advertiser or publisher as an indication of the monetization value of the rich media ad.

7. The method of claim 6, further comprising:
calculating a brand index per impression (BJJ) by dividing BI by the number of impressions.

8. The method of claim 6, wherein the bucket type comprises at least one of ad format and multi-media, and wherein the data types comprise at least one of gif, video, floating, and expandable.

9. The method of claim 6, wherein the bucket type comprises conversion, and wherein the data types comprise at least one of data from filling out a survey, a form, a poll, from printing a coupon, and from downloading product information.

10. A method for calculating brand index (BI) for interactive rich media advertising, comprising:
categorizing advertising exposure of a rich media ad into a type of bucket stored in memory, and for each type of bucket a processor:
collecting a plurality of data types (d₁, d₂, . . . , dₘ) in the bucket;
expressing a bucket brand index (BBI) as a function of the plurality of data types, f(d₁, d₂, . . . , dₘ), wherein the function is finite, non-negative, and real for all non-negative and finite (d);
assigning a bucket weight to each type of bucket stored in memory;
calculating a weighted sum of a plurality of BBIs of the buckets to generate an overall brand index (BI) for an ad campaign by summing the weight of each bucket times the BBI of each respective bucket; and
communicating the BI of the campaign to an advertiser or publisher as an indication of the monetization value of the rich media ad.

11. The method of claim 10, further comprising:
calculating a brand index per impression (BII) by dividing BI by the number of impressions.

12. The method of claim 10, wherein if d>=to d′, then f(d)>=f(d′).

13. The method of claim 10, wherein for BBI=f(d₁, d₂, . . . , dₘ), dBBI/ddᵢ=fᵢ>0 for all data type inputs i=1, 2, . . . , m.

14. The method of claim 13, wherein d²BBI/ddᵢ²=fᵢᵢ<0 for all i=1, 2, . . . , m.

15. The method of claim 10, wherein the bucket type comprises exposure, and wherein the data types comprise at least one of exposure time and a number of layers exposed.

16. The method of claim 10, wherein the bucket type comprises interaction, and wherein the data types comprise at least one of total interaction time and total number of interactions.

17. A method for calculating brand index (BI) for interactive rich media advertising, comprising:
categorizing advertising exposure of some of a plurality of rich media ads into a first type of bucket stored in memory, and for each first type of bucket by a processor:
assigning a weight to each of a plurality of data types collected in the bucket;
assigning a score to each of the data types collected in the bucket;
tracking a frequency of occurrence of each data type; and
calculating the bucket brand index (BBI) for the bucket as a product of the assigned weight, the assigned score, and the tracked frequency; and
categorizing advertising exposure of the remainder of the plurality of rich media ads into a second type of bucket stored in memory, and for each second type of bucket the processor:
collecting a plurality of data types (d₁, d₂, . . . , dₘ) in the bucket stored in memory; and
expressing a bucket brand index (BBI) as a function of the plurality of data types, f(d₁, d₂, . . . , dₘ), wherein the function is finite, non-negative, and real for all non-negative and finite (d);
assigning a bucket weight to each first and second types of buckets stored in memory;
calculating a weighted sum of a plurality of BBIs of the first and second buckets to generate an overall brand index (BI) for an ad campaign by summing the weight of each bucket times the BBI of each respective bucket; and
communicating the BI of the campaign to an advertiser or publisher as an indication of the monetization value of the rich media ad.

18. The method of claim 17, wherein the first bucket type comprises at least one of ad format and multi-media, and wherein the data types comprise at least one of gif, video, floating, and expandable.

19. The method of claim 17, wherein the first bucket type comprises conversion, and wherein the data types comprise at least one of data from filling out a survey, a form, a poll, from printing a coupon, and from downloading product information.

20. The method of claim 17, wherein the second bucket type comprises exposure, and wherein the data types comprise at least one of exposure time and a number of layers exposed.

21. The method of claim 17, wherein the second bucket type comprises interaction, and wherein the data types comprise at least one of total interaction time and total number of interactions.

22. The method of claim 17, wherein communicating the BI to an advertiser comprises communicating the BI to an advertising server, and wherein communicating the BI to an publisher comprises communicating the BI to a campaign management server.
